(19) United States
(12) Patent Application Publication
(10) Pub. No.: US 2025/0190920 A1
(43) Pub. Date: Jun. 12, 2025

(54) EXPERIENCE QUOTIENT

(71) Applicant: SAP SE, Walldorf (DE)

(72) Inventors: Caitlynn Sendra, Mount Prospect, IL (US); Scott Lietzke, Forestville, CA (US); Julie Bartholic, Carlsbad, CA (US)

(21) Appl. No.: 18/532,686

(22) Filed: Dec. 7, 2023

(51) Int. Cl. G06Q 10/0639; G06F 16/28

(52) U.S. Cl. CPC G06Q 10/06395; G06F 16/288

(57) ABSTRACT

The present disclosure involves systems, software, and computer implemented methods for performing human capital management. One example method includes obtaining psychological capital (PsyCap) driver data including one or more PsyCap drivers, obtaining personality data, obtaining PsyCap pulse data, obtaining event data including one or more events, accessing data from a Human Resource Management System (HRMS), converting the PsyCap driver data, the personality data, the PsyCap pulse data, and the event data into a standardized format, processing the PsyCap driver data, the personality data, the PsyCap pulse data, the event data, and the data from the HRMS through a machine learning predictive model to generate an assessment result, and providing recommendation or intervention based on the assessment result by providing a link to an opportunity managed by an application.

### TECHNICAL FIELD

The present disclosure relates to computer-implemented methods, software, and systems for measuring and determining a person's abilities to improve human capital management computer systems.

### BACKGROUND

Human capital management provides a mechanism for measuring a person's capability. Current human capital management solutions focus on personal experience (such as educational and work experience) and social experience to measure the person's capability. While these are important, they fail to provide a more complete picture of a person to assist in helping that person thrive in a work environment.

### SUMMARY

The present disclosure involves systems, software, and computer implemented methods for performing human capital management. An example method includes obtaining psychological capital (PsyCap) driver data stored in a first database in a first data format, where the PsyCap driver data includes one or more PsyCap drivers, obtaining personality data stored in a second database in a second data format, obtaining PsyCap pulse data in a first format by providing a first graphical user interface (GUI) element that is superimposed over a second GUI element from a software application in which a link is provided in the first GUI element that redirects a user to provide the PsyCap pulse data, obtaining event data in a third data format, where the event data includes one or more events, accessing data from a Human Resource Management System (HRMS), where the data from the HRMS includes at least one of growth opportunities, team assignments, projects, work activities, goals, or accomplishments, converting the PsyCap driver data, the personality data, the PsyCap pulse data, and the event data into a standardized format, processing the PsyCap driver data, the personality data, the PsyCap pulse data, the event data, and the data from the HRMS through a machine learning predictive model to generate an assessment result, and providing recommendation or intervention based on the assessment result by providing a third GUI element, where the third GUI element includes a link to an opportunity managed by a third application.

In some instances, the personality data is obtained through a personality test, and the PsyCap pulse data is obtained through polls during experience quotient (XQ) onboarding and is obtained after the personality data is obtained.

In some instances, the assessment result includes a PsyCap score, a Hope score, a Self-Efficacy score, a Resilience score, an Optimism score, a top PsyCap positive contributing experience, and a top PsyCap negative contributing experience.

In some instances, the personality data and the PsyCap pulse data are associated with an employee, the PsyCap result includes a PsyCap score of the employee, and providing the recommendation or the intervention based on the PsyCap result includes recommending an opportunity to the employee based on the PsyCap score of the employee.

In some instances, the personality data and the PsyCap pulse data are associated with employees in a team, the PsyCap result includes an aggregated PsyCap score of each employee in the team, and providing the recommendation or the intervention based on the PsyCap result includes recommending a team learning or training if the aggregated PsyCap score is lower than a previously stored score.

In some instances, the personality data and the PsyCap pulse data are associated with a team leader, the PsyCap result includes a PsyCap score of the team leader, and providing the recommendation or the intervention based on the PsyCap result includes determining that the PsyCap score of the team leader is lower than a threshold, identifying a PsyCap driver from the one or more PsyCap drivers that cause low PsyCap score, and providing the recommendation or the intervention based on the identified PsyCap driver.

In some instances, the personality data and the PsyCap pulse data are associated with employees in an organization, the PsyCap result includes a mean of organization employees' PsyCap scores, and providing the recommendation or the intervention based on the PsyCap result includes identifying one or more hidden boosters of motivation in the organization.

In some instances, the method further comprises identifying a new event, sending 4-item pulse to one or more employees after the new event occurred, receiving employee feedback on the 4-item pulse, and calculating a relationship between the new event and PsyCap.

While generally described as computer-implemented software embodied on tangible media that processes and transforms the respective data, some or all of the aspects may be computer-implemented methods or further included in respective systems or other devices for performing this described functionality. The details of these and other aspects and embodiments of the present disclosure are set forth in the accompanying drawings and the description below. Other features, objects, and advantages of the disclosure will be apparent from the description and drawings, and from the claims.

### DESCRIPTION OF DRAWINGS

FIG. 1 is a block diagram illustrating an example computer system for performing human capital management.

FIG. 2 is a block diagram illustrating an example 4-item psychometric assessment.

FIG. 3 is a block diagram illustrating example psychological capital (PsyCap) drivers.

FIG. 4 is a block diagram illustrating an example aspect of PsyCap drivers.

FIG. 5 is a block diagram illustrating another example aspect of PsyCap drivers.

FIG. 6 is a flow diagram of an example process for measuring PsyCap.

FIG. 7 is a flow diagram of an example process for experience quotient (XQ) data management.

FIG. 8 is a flowchart of an example method for recommending XQ intervention based on PsyCap assessment.

### DETAILED DESCRIPTION

The following detailed description describes a computer system and method to assist in human capital management. Various modifications to the disclosed implementations will be readily apparent to those skilled in the art, and the general principles defined herein may be applied to other implementations and applications without departing from scope of the disclosure. Thus, the present disclosure is not intended to be limited to the described or illustrated implementations, but is to be accorded the widest scope consistent with the principles and features disclosed herein.

Organizations are constantly striving to gain a competitive advantage through their employees. Internal readiness, ingenuity, determination, and the ability to innovate and transform are key to executing any business strategy. The goal of human resources (HRs) and talent leaders is to build a capable workforce that can adapt, change, and grow even in complex situations. Utilizing a tool to measure employees' openness and adaptability can help achieve this goal. Existing solutions focus on measuring human capital in “what you know” (such as skills and competencies) and social capital in “who you know”, without considering psychological capital (PsyCap) of their employees. These solutions are flawed, as an employees' psychological state can greatly motivate or demotivate the employees' attitude, performance, and behavior at work. When in a higher psychological state, the employee usually performs better. In accordance with principles of this disclosure, PsyCap, which captures an individual's psychological state of openness and adaptability, can be measured, developed, and used to improve the individual's work performance and job satisfaction.

Different from existing solutions, this specification introduces a new tool, namely, an experience quotient (XQ) tool, that utilizes scientifically-proven PsyCap drivers to create measurement moments, tracking, and interventions (e.g., actions to improve PsyCap) through enterprise human resource management systems. Using the XQ tool, human resources and talent leaders are able to predict, measure, track, and inform employees of their PsyCap, resulting in meaningful, positive changes to the workforce. For example, the XQ tool can help identify root cause drivers of PsyCap in an employee's daily work, and can then recommend actions that motivate the employee to achieve optimal performance. In addition, the XQ tool can be applied to a large workforce at multiple levels (such as, individual level, team level, and organizational level). As a result, the XQ tool can help drive individuals, teams, and organizations to reach their full potential. In the PsyCap state where employees are open, adaptable, and ready to take on challenges, creativity, innovation, revenue, organizational commitment, and employee welfare flourish. Similar technologies can be used in any interpersonal solution, including job opportunities, skills training opportunities, volunteer opportunities, mentor-related assignments, career development plans, talent discovery, team building and cohesion, and any other suitable implementation.

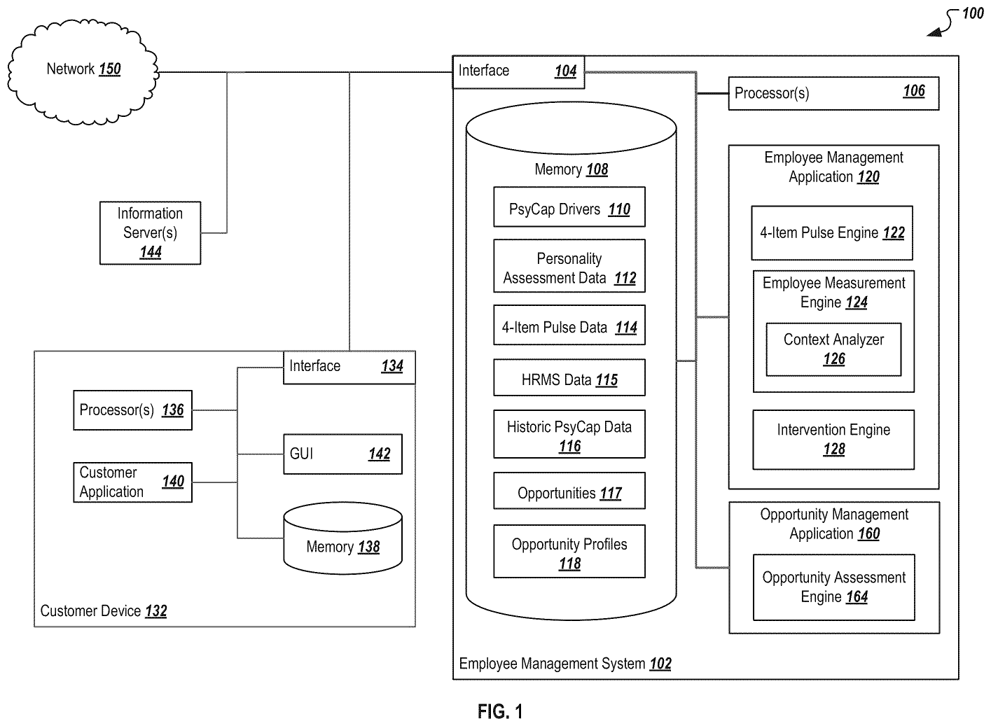

Turning to the illustrated embodiment, FIG. 1 is a block diagram illustrating an example computer system 100 for performing human capital management. Specifically, the illustrated system 100 includes or is communicably coupled with an employee management system 102, a customer device 132, one or more information server(s) 144, and a network 150. Although shown separately, in some implementations, functionality of two or more systems or servers may be provided by a single system or server. In some implementations, the functionality of one illustrated system, server, or component may be provided by multiple systems, servers, or components, respectively.

As used in the present disclosure, the term “computer” is intended to encompass any suitable processing device. For example, although FIG. 1 illustrates a single employee management system 102 and a single customer device 132, the system 100 can be implemented using a single, stand-alone computing device, two or more servers, and/or two or more customer devices. Indeed, the employee management system 102 may be any computer or processing device such as, a blade server, general-purpose personal computer (PC), Mac®, workstation, UNIX-based workstation, or any other suitable device. In other words, the present disclosure contemplates computers other than general-purpose computers, as well as computers without conventional operating systems. Further, the employee management system 102 and the customer device 132 may each be adapted to execute any operating system, including Linux, UNIX, Windows, Mac OS®, Java™, Android™, iOS, or any other suitable operating system. According to one implementation, the employee management system 102 may also include or be communicably coupled with one or more information servers 144 as illustrated in FIG. 1. For example, the information servers 144 may include, among others, a communication server, an e-mail server, a web server, a caching server, a streaming data server, and/or other suitable servers or computers. These servers 144 may associated with, or may be, related to social media services or application, entertainment platforms, information services, retail solutions and websites, and communication servers (e.g., email or chat features). These various servers 144 allow the system to collect data relevant to employees from or at these servers 144, and can use that relevant data to measure employees' PsyCap. In some instances, the servers 144 may be “third-party” servers (e.g., related to social media and/or other data repositories), but some may be email or other servers owned or managed by the organization performing PsyCap measurement. A combination of such information can be collected from two or more information servers 144.

Organizations, such as small and midsize enterprises (SMEs), large enterprises, or other types of organizations, can use the employee management system 102 for employee management. In some implementations, the employee management system 102 may be incorporated into an organization's overall Human Resources Management System (HRMS). Other systems that may be included in an HRMS may include administration, payroll, time management, learning management, talent acquisition, etc. In general, employee management system 102 may be any suitable computing server or system executing applications related to requests for performing employee management including, for example, opportunity recommendations or interventions. The employee management system 102 is described herein in terms of responding to requests for performing employee management and other data from users at customer device 132 and other clients, as well as other systems communicably coupled to network 150 or directly connected to the employee management system 102. However, the employee management system 102 may, in some implementations, be a part of a larger system providing additional functionality. For example, employee management system 102 may be part of an enterprise business application or application suite providing one or more of enterprise relationship management, data management systems, customer relationship management, and others. In one example, employee management system 102 may generate or receive a request to measure employee's PsyCap after an event occurs, send a psychometric assessment (e.g., a 4-item pulse survey) related to the event to the employee, receive the employee's response, access data related to the employee from a database, process the data and the employee's response through a machine learning model to measure or predict the employee's PsyCap at the moment, and respond to the requestor with the employee's PsyCap and/or one or more intervention recommendations to improve the employee's PsyCap. The machine learning model can be trained and enhanced with the employee's input and feedback. In some implementations, the employee management system 102 may be associated with a particular uniform resource locator (URL) for web-based applications. The particular URL can trigger execution of multiple components and systems.

As illustrated, employee management system 102 includes an interface 104, one or more processors 106, memory 108, and an employee management application 120. In general, the employee management system 102 is a simplified representation of one or more systems and/or servers that provide the described functionality, and is not meant to be limiting, but rather an example of the systems possible.

The interface 104 is used by the employee management system 102 for communicating with other systems in a distributed environment—including within the system 100—connected to the network 150 (e.g., customer device 132, information server(s) 144, and other systems communicably coupled to the network 150). Generally, the interface 104 may comprise logic encoded in software and/or hardware in a suitable combination and operable to communicate with the network 150. More specifically, the interface 104 may comprise software supporting one or more communication protocols associated with communications, such that the network 150 or interface's hardware is operable to communicate physical signals within and outside of the illustrated system 100.

Network 150 facilitates wireless or wireline communications between the components of the system 100 (e.g., between employee management system 102 and customer device 132 and among others), as well as with any other local or remote computer, such as additional clients, servers, or other devices communicably coupled to network 150, including those not illustrated in FIG. 1. In the illustrated system, the network 150 is depicted as a single network, but may be comprised of more than one network without departing from the scope of this disclosure, so long as at least a portion of the network 150 may facilitate communications between senders and recipients. In some instances, one or more of the illustrated components may be included within network 150 as one or more cloud-based services or operations. For example, the employee management system 102 may be a cloud-based service. The network 150 may be all or a portion of an enterprise or secured network, while in another instance, at least a portion of the network 150 may represent a connection to the Internet. In some instances, a portion of the network 150 may be a virtual private network (VPN). Further, all or a portion of the network 150 can comprise either a wireline or wireless link. Example wireless links may include 802.11ac/ad/af/a/b/g/n, 802.20, WiMax, LTE, and/or any other appropriate wireless link. In other words, the network 150 encompasses any internal or external network, networks, sub-network, or combination thereof operable to facilitate communications between various computing components inside and outside the illustrated system 100. The network 150 may communicate, for example, Internet Protocol (IP) packets, Frame Relay frames, Asynchronous Transfer Mode (ATM) cells, voice, video, data, and other suitable information between network addresses. The network 150 may also include one or more local area networks (LANs), radio access networks (RANs), metropolitan area networks (MANs), wide area networks (WANs), all or a portion of the Internet, and/or any other communication system or systems at one or more locations.

As illustrated in FIG. 1, the employee management system 102 includes one or more processors 106. Each processor 106 may include a central processing unit (CPU), an application-specific integrated circuit (ASIC), a field-programmable gate array (FPGA), or another suitable component. Generally, each processor 106 executes instructions and manipulates data to perform the operations of the employee management system 102. Specifically, each processor 106 executes the algorithms and operations described in the illustrated figures, including the operations performing the functionality associated with the employee management system 102 generally, as well as the various software modules (e.g., the employee management application 120), including the functionality for sending communications to and receiving transmissions from customer device 132.

The employee management system 102 also includes an employee management application 120 that implements, for example, the XQ tool. The employee management application 120 provides a PsyCap measurement method and an intervention recommendation method. In operation, the employee management application 120 measures employee's PsyCap by processing different sets of data (such as, PsyCap drivers, personality assessment data, 4-item pulse data, and work-related data available in a Human Resource Management System (HRMS)) through a machine learning model, provides an intervention recommendation (such as, recommending a new job opportunity, a particular skill learning course, and a certain career path) to improve the employee's PsyCap, and trains the machine learning model using the employee's input and feedback. Operations of the employee management application 120 are executed by the one or more processors 106. In some implementations, the employee management application 120 may be a software program, or set of software programs, executing on the employee management system 102. In various alternative implementations, the employee management application 120 may also be an external component from the employee management system 102 and may communicate with the employee management system 102 over a network (e.g., network 150).

As shown, the employee management application 120 includes the 4-item pulse engine 122. The 4-item pulse engine 122 generates 4-item pulse related to four PsyCap related items, namely hope, self-efficacy, resilience, and optimism. In operation, the 4-item pulse engine 122 may send a 4-item pulse survey or questionnaire to employee(s) when instructed by the employee measurement engine 124. An employee's response to the 4-item pulse survey or questionnaire can help the employee management application 120 make fast psychometric assessment while maintaining reliability and effectiveness when compared to other psychometric assessments (such as a self-report 24-item psychometric assessment). In some implementations, the employee management application 120 can include a pulse engine that generates a pulse related to a variety of different PsyCap related items. An example of a 4-item pulse can include, for instances, several questions. Those questions may allow the user or employee to rate or rank a response to questions including, for example:
Q1, I feel hopeful about my work.
Q2, I am confident that I will be successful.
Q3, When I face challenges at work, I can overcome them.
Q4, I am optimistic about the success of my work.

The employee measurement engine 124 measures or predicts employee's PsyCap that captures the employee's current psychological state. In operation, the employee measurement engine 124 may obtain one or more of PsyCap driver data 110, personality assessment data 112, 4-item pulse data 114, HRMS data 115, and data from other sources (such as public websites), and process the obtained data through a machine learning model to generate PsyCap measurement. For example, the PsyCap driver data 110 includes measurement data indicative of what provides a generally more positive outlook for each employee. The PsyCap driver data 110 includes data indicative of scientifically-proven PsyCap drivers (such as, performance goals, development goals, career aspirations, peer or manager feedback, and skill or capability building) and user-identified PsyCap drivers (such as, “I get to work on things I'm good at” and “The work I do is aligned to my passions and interests”). In some cases, each user-identified PsyCap driver needs to be tested to comply with scientific standards, such as those for the scientifically-proven PsyCap drivers, before being included in the PsyCap driver data. The personality assessment data 112 can include data obtained through the personality assessment (such as the Big Five personality test). In some cases, the data corresponding to the personality assessment is captured only once for each employee and is used for PsyCap measurement until the employee changes the answer to the personality assessment. The 4-item pulse data 114 can include data obtained from employee's response to the 4-item pulse. The HRMS data 115 can include moments (such as, onboarding and personal achievement) dynamically captured throughout a person's career journey, and employees' daily and ongoing work data (such as, growth opportunities, team assignments, projects, work activities, goals, and accomplishments). In some cases, the HRMS data 115 can include large-scale workforce events defined by an organization or administrator. The data from other sources can be inferred from, for example, Office 365, Mail, Calendar Systems, public websites, and/or systems internal/external to the organization. Examples include experience data inferred from events in an employee's calendar (such as, “Had a 1-1 with manager” and “Had an All-Hands meeting”). In some instances, HRMS data 115 includes experience data that can be inferred from employee's social media posts (such as on Facebook, LinkedIn, and Twitter). In some instances, the user or employee may have the opportunity to validate the inference as accurate or inaccurate before the experience data is associated with the employee.

In one implementation, employee management system 102 can collect experience data from both structured and unstructured sources. For structured data collection, the user typically answers probing questions directly. As an example, a prompt on a computer UI may ask the question: “Could you please list positive or negative work experiences?” The typed response by the user is stored in a data field that may be labeled “Positive Experiences” or “Negative Experiences”, that is associated with another data field labeled “Experiences.” Information about particular job experience can also be obtained via prompts, as well as inferred from submitted information or available information related to the user.

To collect unstructured data, employee management system 102 may receive a scanned copy of a paper document where the scanner uses optical scan recognition. The scanned data is received and processed through a context analyzer 126 (of an employee measurement engine 124). The context analyzer 126 then takes certain data entries and assigns them proper labels for later retrieval and processing (i.e., converts the unstructured data to structured data). In other instances, unstructured data may be obtained via data entry, from documents scanned using optical character recognition (OCR), from digital files or documents associated with users, or any other suitable source.

By considering different sets of data through the machine learning model, the employee measurement engine 124 can provide accurate PsyCap measurement for an individual, a team, and/or the organization. In some cases, PsyCap measurement may include a consolidated and higher-order construct score for the individual's PsyCap, and four individual scores for the individual's hope, self-efficacy, resilience, and optimism, respectively. The direct user input and/or user feedback regarding a presented PsyCap measurement generated by the employee measurement engine 124 for an individual can be used to train and enhance the machine learning model to improve PsyCap accuracy. In some cases, PsyCap measurement may include team score and organization score. With the team score and the organization score, organization and HR leaders are able to fill key information blind spots (such as “Is my team/organization ready for change?”). Operations of the employee measurement engine 124 are executed by the one or more processors 106. In some implementations, the employee measurement engine 124 may be a software program, or set of software programs, executing on the employee management system 102. In various alternative implementations, the employee measurement engine 124 may also be an external component from the employee management system 102 and may communicate with the employee management system 102 over a network (e.g., network 150).

The employee measurement engine 124 includes the context analyzer 126 that provides context and structure for received unstructured data. In addition, the employee measurement engine 124 tracks user activity to determine if a user PsyCap reassessment is necessary after a user-related work event has occurred. Such work events may include, but are not limited to, completion of a project, a release date for a product, a company reorganization, etc. In one implementation, employee measurement engine 124 tracks a user's PsyCap measurement over time and can determine whether a user's PsyCap has decreased over time such that a new opportunity may be recommended by an intervention engine 128 to the user to improve the user's PsyCap.

Intervention engine 128 compares a current PsyCap measurement with the previous PsyCap measurement, and can then automatically recommend an opportunity or intervention (or multiple of either or each) for a user when the PsyCap decreases by a predefined threshold, or is persistently low relative to a standard score or to the employee's historical score. The intervention engine 128 may include a series of learning content, interactive exercises, and proprietary machine-learning (ML)-supported PsyCap interventions. The inherent PsyCap drivers in the employee management system 102, as well as intervention boosters from 3rd party content providers, can be used as input to the intervention engine 128 to provide an intelligent intervention feature. For example, hope in the workforce can be improved by setting aspirations and meaningful goals. Self-efficacy or confidence can be improved through experiential or learning sessions offered by the HR management solutions. In operation, when the current PsyCap needs to be improved, the intervention engine 128 identifies one or more opportunities 117 that are associated with the PsyCap boosters, and presents or selects the one or more opportunities 117 to the user. The opportunity 117 can include a new project, a new team, a new skill training session, a new leadership opportunity, a certain career path, a certain career development program, goal setting, aspiration setting, and personality, strengths, and styles reassessments, among others. For example, when an employee's PsyCap is low (e.g., having a PsyCap score lower than the team member's average score, or low relative to a threshold score, etc.), an opportunity can be recommended to the employee to improve employee's psychological state. When a team PsyCap is low (e.g., the team member's average score declining over time), a team training can be recommended to improve the team PsyCap. When an organization PsyCap increases unexpectedly, one or more hidden boosters of motivation in the organization can be identified. The hidden boosters, once identified, can be stored for future recommendations. Operations of the intervention engine 128 are executed by the one or more processors 106. In some implementations, the intervention engine 128 may be a software program, or set of software programs, executing on the employee management system 102. In various alternative implementations, the intervention engine 128 may also be an external component from the employee management system 102 and may communicate with the employee management system 102 over a network (e.g., network 150).

Regardless of the particular implementation, “software” includes computer-readable instructions, firmware, wired and/or programmed hardware, or any combination thereof on a tangible medium (transitory or non-transitory, as appropriate) operable when executed to perform at least one of the processes and operations described herein. In fact, each software component may be fully or partially written or described in any appropriate computer language, including C, C++, JavaScript, JAVA™, VISUAL BASIC, assembler, Perl®, any suitable version of 4GL, as well as others. While portions of the software elements illustrated in FIG. 1 are shown as individual modules that implement the various features and functionality through various objects, methods, or other processes, the software may instead include a number of sub-modules, third-party services, components, libraries, and such, as appropriate. Conversely, the features and functionality of various components can be combined into single components, as appropriate.

As illustrated, employee management system 102 includes memory 108. In some implementations, the employee management system 102 includes multiple memories. The memory 108 may include any memory or database module and may take the form of volatile or non-volatile memory including, without limitation, magnetic media, optical media, random access memory (RAM), read-only memory (ROM), removable media, or any other suitable local or remote memory component. The memory 108 may store various objects or data, including financial and/or business data, application information including URLs and settings, user information, behavior and access rules, administrative settings, password information, caches, backup data, repositories storing business and/or dynamic information, and any other appropriate information including any parameters, variables, algorithms, instructions, rules, constraints, or references thereto associated with the purposes of the employee management system 102. Additionally, the memory 108 may store any other appropriate data, such as VPN applications, firmware logs and policies, firewall policies, a security or access log, print or other reporting files, as well as others. For example, illustrated memory 108 includes PsyCap drivers 110, personality assessment data 112, 4-item pulse data 114, HRMS data 115, historic PsyCap data 116, opportunities 117, and opportunity profiles 118.

The PsyCap drivers 110 stores scientifically-proven PsyCap drivers and user-identified PsyCap drivers. For example, the scientifically-proven PsyCap drivers can include one or more of performance goals, development goals, career aspirations, skill or capability building, rewards, recognition, leader or manager PsyCap, team or organizational PsyCap, peer or manager feedback, team effectiveness, team climate, organizational goals, and organizational objectives and key results (OKRs). The user-identified PsyCap drivers can include one or more of alignment to SAP SuccessFactors Whole Self Model, “I get to work on things I am good at”, “The work I do is aligned to my passions and interests”, “My company has recently been performing well financially”, and “I am able to see my work projects through from beginning to end”. The personality assessment data 112 stores user data related to an individual's innate traits. The personality assessment data 112 can include one or more of personality dimensions, openness to experience, conscientiousness, extraversion, agreeableness, and neuroticism. These sets of information can be received through any suitable manner, including personality tests, self-evaluations, and observed behavior capture. For example, the information can be obtained through validated psychometric assessments. The assessments may include reviews, personality tests (such as the Big Five personality test), and other suitable forms. The assessments may be administered within or outside an organization, and may vary based upon desired attribute types (such as, innate strengths for leadership, interpersonal communications, team dynamics, and approaches to work and problem-solving). The 4-item pulse data 114 stores an individual's response to 4-item pulse survey. The HRMS data 115 stores work-related data available in the HRMS. For example, the HRMS data 115 can include moments (such as, onboarding and personal achievement) dynamically captured throughout a person's career journey, and employees' daily and ongoing work data (such as, growth opportunities, team assignments, projects, work activities, goals, and accomplishments). In some cases, the HRMS data 115 can include large-scale workforce events defined by an organization or administrator. The historic PsyCap data 116 stores the previous PsyCap measurement, and may store one or more other historical PsyCap measurements.

Employee management system 102 also contains opportunity management application 160. Similar to the employee management application 120, opportunity management application 160 evaluates opportunities so the intervention engine 128 can provide matching opportunities. Opportunity management application 160 includes opportunity assessment engine 164. The opportunity assessment engine 164 receives opportunities 117 from memory 108 and evaluates them to extract relevant portions that can be used by the intervention engine 128. The relevant portions from an opportunity are then stored as opportunity profiles 118 in memory 108.

Customer device 132 may be any computing device operable to connect to or communicate with employee management system 102, other information servers 144, other clients (not illustrated), or other components via network 150, as well as with the network 150 itself, using a wireline or wireless connection, and can include a desktop computer, a mobile device, a tablet, a server, or any other suitable computer device. In general, customer device 132 comprises an electronic computer device operable to receive, transmit, process, and store any appropriate data associated with the system 100 of FIG. 1.

As illustrated, customer device 132 includes an interface 134, one or more processors 136, a graphical user interface (GUI) 142, a customer application 140, and memory 138. Interface 134 and one or more processors 136 may be similar to, or different than, interface 104 and one or more processors 106 described with regard to employee management system 102. In general, each processor 136 executes instructions and manipulates data to perform the operations of the customer device 132. Specifically, each processor 136 can execute some or all of the algorithms and operations described in the illustrated figures, including the operations performing the functionality associated with the customer application 140 and the other components of customer device 132. Similarly, interface 134 provides the customer device 132 with the ability to communicate with other systems in a distributed environment-including within the system 100—connected to the network 150.

The customer device 132 includes or presents the GUI 142. For example, the GUI 142 provides a user interface between a user and the customer application 140. In some operations, the user uses the GUI 142 to request an intervention recommendation. The GUI 142 may display multiple interventions recommended by the employee management application 120 for the user to select. In some implementations, the GUI 142 may be a software program, or set of software programs, executing on the customer device 132. The GUI 142 may also be an external component from the customer device 132 and may communicate with the customer device 132 over a network (e.g., network 150).

The GUI 142 of the customer device 132 interfaces with at least a portion of the system 100 for any suitable purpose, including generating a visual representation of the customer application 140 and/or other applications. In particular, the GUI 142 may be used to view and navigate various Web pages, or other user interfaces. Generally, the GUI 142 provides the user with an efficient and user-friendly presentation of business data provided by or communicated within the system. The GUI 142 may comprise a plurality of customizable frames or views having interactive fields, pull-down lists, and buttons operated by the user. The GUI 142 contemplates any suitable graphical user interface, such as a combination of a generic web browser, intelligent engine, and command line interface (CLI) that processes information and efficiently presents the results to the user visually.

The customer device 132 can include one or more client applications, including the customer application 140. In general, a client application is any type of application that allows the customer device 132 to request and view content on the respective device. In some implementations, a client application can use parameters, metadata, and other information received at launch to access a particular set of data from the employee management system 102. In some instances, a client application may be an agent or client-side version of the one or more enterprise applications running on an enterprise server (not shown). Customer application 140 may work with one or more other information servers 144. In addition, a user's interactions with customer application 140 may be forwarded to employee measurement engine 124, so that the employee measurement engine 124 may detect if the user's psychological state has changed.

Customer device 132 executes the customer application 140. The customer application 140 may operate with or without requests to the employee management system 102—in other words, the customer application 140 may execute its functionality without requiring the employee management system 102 in some instances, such as by accessing data stored locally on the customer device 132. In others, the customer application 140 may be operable to interact with the employee management system 102 by sending requests via network 150 to the employee management system 102 for performing human capital management. For example, a user can use the customer application 140 to request an intervention recommendation (such as, recommending a new job opportunity, a particular skill learning course, and a certain career path). In some cases, managers can use the customer application 140 to view PsyCap-related information associated with one or more employees for whom they may be managing. In some implementations, the customer application 140 may be a standalone web browser, while in others, the customer application 140 may be an application with a built-in browser. The customer application 140 can be a web-based application or a standalone application, developed for the particular customer device 132. For example, the customer application 140 can be a native iOS application for iPad, a desktop application for laptops, as well as others.

Memory 138 may be similar to or different from memory 108 of the employee management system 102. In some implementations, the customer device 132 includes multiple memories. In general, memory 138 may store various objects or data, including any parameters, variables, algorithms, instructions, rules, constraints, or references thereto, associated with the purposes of the customer device 132. Additionally, the memory 138 may store any other appropriate data, such as VPN applications, firmware logs and policies, firewall policies, a security or access log, print or other reporting files, as well as others.

The illustrated customer device 132 is intended to encompass any computing device such as a desktop computer, laptop/notebook computer, mobile device, smartphone, personal data assistant (PDA), tablet computing device, one or more processors within these devices, or any other suitable processing device. For example, the customer device 132 may comprise a computer that includes an input device, such as a keypad, touch screen, or other device that can accept user information, and an output device that conveys information associated with the operation of the customer application 140 or the customer device 132 itself, including digital data, visual information, or the GUI 142, as shown with respect to the customer device 132. Further, while illustrated as a client system, customer device 132 may be exchanged with another suitable source for performing human capital management in other implementations, and is not meant to be limiting.

There may be any number of customer devices 132 associated with, or external to, the system 100. For example, while the illustrated system 100 includes one customer device 132, alternative implementations of the system 100 may include multiple customer devices 132 communicably coupled to the employee management system 102 and/or the network 150, or any other number suitable to the purposes of the system 100. Additionally, there may also be one or more additional customer devices 132 external to the illustrated portion of system 100 that are capable of interacting with the system 100 via the network 150. Further, the term “client”, “client device”, and “user” may be used interchangeably as appropriate without departing from the scope of this disclosure. Moreover, while the customer device 132 is described in terms of being used by a single user, this disclosure contemplates that many users may use one computer, or that one user may use multiple computers.

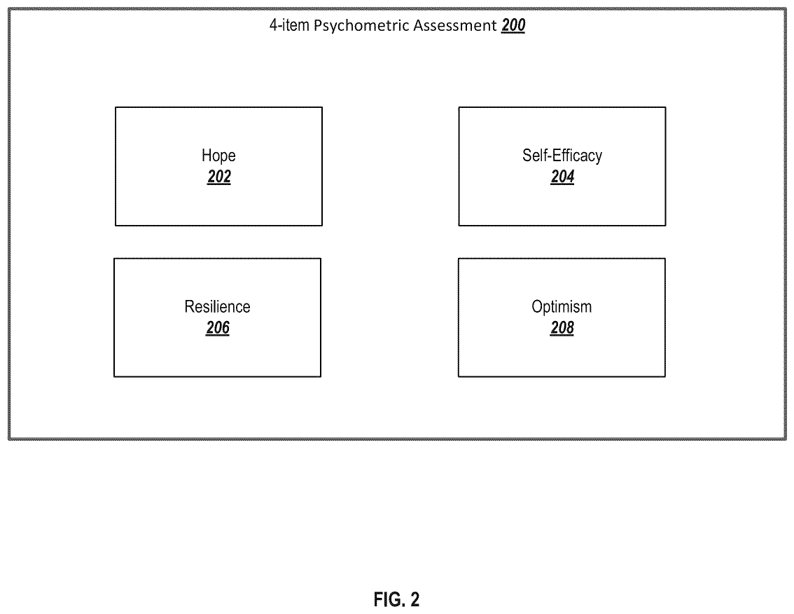

FIG. 2 is a block diagram illustrating an example 4-item psychometric assessment 200. A psychometric assessment can include different measurement items related to different user aspects, and can provide an assessment of the user's psychological capacity. As illustrated in FIG. 2, the 4-item psychometric assessment 200 includes four measurement items, namely hope 202, self-efficacy 204, resilience 206, and optimism 208. In some implementations, the example psychometric assessment 200 can include additional items, fewer items, and/or different items.

PsyCap can be measured, in some instances, through surveys. For example, a self-report 24-item psychometric assessment, known as the PsyCap Questionnaire (PCQ-24), has been used as a standard psychometric measurement tool. The PCQ-24 includes 24 individual PsyCap related items, which take 10-15 minutes to be completed by the individual. Instead of using the PCQ-24, the shorter 4-item psychometric assessment (4-item pulse) 200 has been proposed in the XQ tool. With only four individual PsyCap related items, the 4-item pulse provides the XQ tool with fast psychometric assessment while maintaining reliability and effectiveness when compared to the PCQ-24. Research shows a final alpha reliability coefficient of 0.85 for the 4-item pulse, which is considered excellent. In addition, the 4-item pulse demonstrates sufficient proof of construct validity with correlation r=0.79 to published PsyCap measures, and convergent validity with significant correlations to aligned constructs (such as engagement r=0.63, job satisfaction r=0.44, and organizational trust r=0.63).

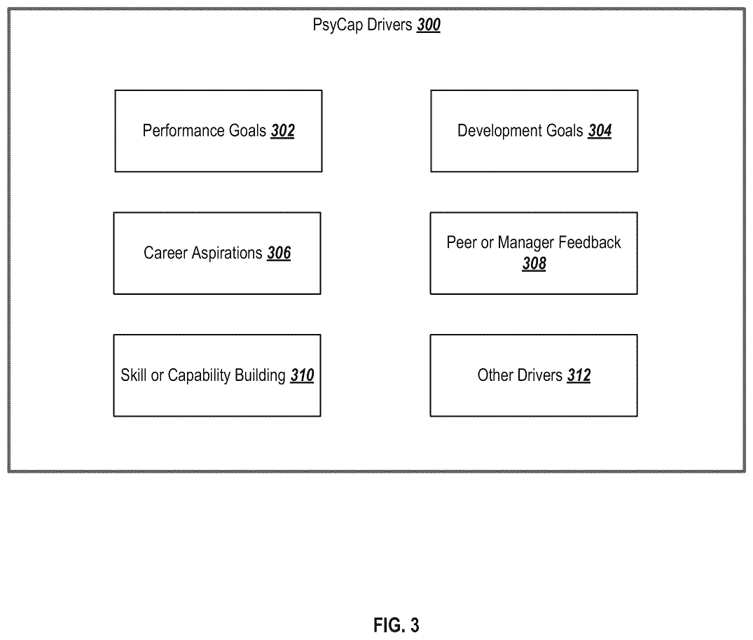

FIG. 3 is a block diagram illustrating example PsyCap drivers 300. PsyCap drivers can include scientifically-proven PsyCap drivers and user-identified PsyCap drivers. As illustrated in FIG. 3, the example PsyCap drivers 300 include performance goals 302, development goals 304, career aspirations 306, peer or manager feedback 308, skill or capability building 310, and other drivers 312. In some implementations, the example PsyCap drivers 300 can include additional drivers, fewer drivers, and/or different drivers.

As mentioned above, PsyCap is traditionally measured by using a psychometric assessment measuring a person's feelings at the moment. For example, the psychometric assessment may ask: “Are you confident in setting goals for your work?” Based on the psychometric assessment, we may know that the person is confident in setting work goals (i.e., the psychometric assessment indicating a high PsyCap score), but we may not know why the person is confident in setting work goals. In contrast, the XQ tool takes a unique approach to obtain a deeper understanding of PsyCap by capturing PsyCap drivers or experience in the workflow. The XQ tool can help determine a root cause of the high PsyCap score. For example, the person's confidence can be boosted by learning a new skill, achieving challenging goal, or having a supportive conversation with a manager or mentor.

In a Human Resource Management System (HRMS), moments (such as, onboarding and personal achievement, among others) can be captured dynamically throughout a person's career journey, and the person's experience can be derived from those captured moments. In addition, the HRMS contains employees' daily and ongoing work data (such as, growth opportunities, team assignments, projects, work activities, goals, and accomplishments). Using data from the HRMS to measure PsyCap provides a deeper understanding of the root causes of a person's satisfaction and fulfillment at work, as well as experiences that negatively impact the person's mindset and outlook. For example, such information can include what is building or driving a person's PsyCap (e.g., PsyCap boosters) and what is depleting or draining the person's PsyCap (e.g., PsyCap drainers).

As noted, PsyCap drivers can include scientifically-proven PsyCap drivers. Examples of those PsyCap drivers may include, but are not limited to, the following drivers:
Performance Goals
Development Goals
Stretch Goals
Organizational Goals
Organizational Objectives and Key Results (OKRs)
Career Aspirations
Defined Career Path
Skill or Capability Building
Continuous Performance Activities
Leader or Manager PsyCap
Team or Organizational PsyCap
Peer or Manager Feedback
360 or Assessed Capability Measurement
Rewards
Recognition
Growth Experiences
Psychological Safety
Climate or Culture
Projects or Work Aligned to Interests
Agency or Self Direction of Career
Manager or Leader Relationship
Social Relationships
Team Effectiveness
Job Crafting
Job Variety
Job Stability
Job Demands
Team Climate
Potential Indicators
People Sustainability Score

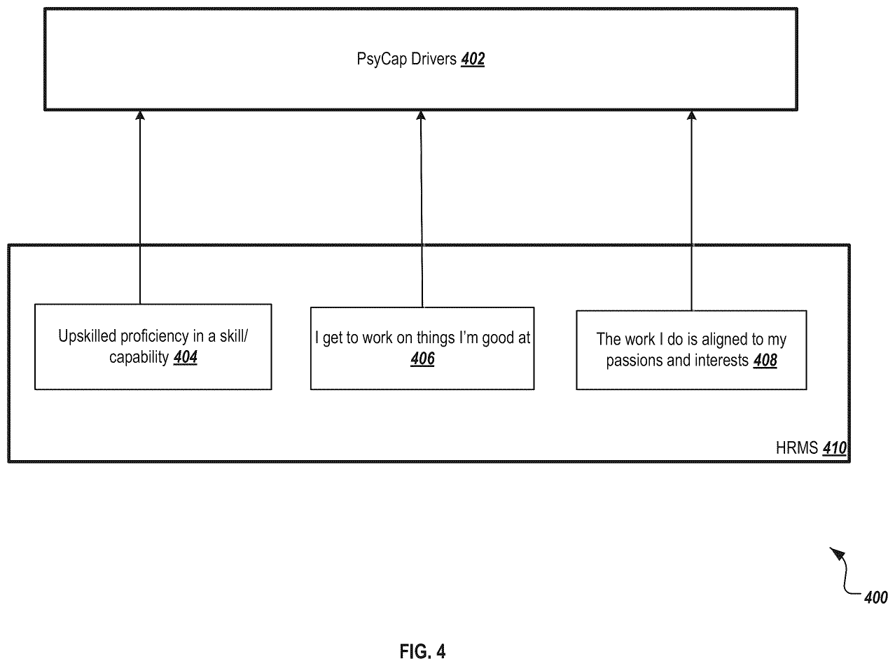

FIG. 4 is a block diagram illustrating an example aspect 400 of PsyCap drivers. As illustrated in FIG. 4, PsyCap drivers 402 can be associated with data from a HRMS 410. In some implementations, the PsyCap drivers 402 can be associated with data from additional sources and/or different sources.

Each PsyCap driver of the PsyCap drivers 402 can be associated with one or more event triggers, a response to prompt, or experience from the HRMS 410. For example, when an employee-related work event (e.g., upskilled proficiency in a skill/capability 404) is detected in the HRMS 410, the XQ tool is triggered to send a PsyCap probing question about that moment to the employee. The probing question may ask: “You have improved your proficiency level in statistical analysis. Does this give you confidence in your ability to succeed?” Employee feedback improves the accuracy of a predicted PsyCap enabling moment, both positively and negatively. In some cases, a probing question may ask: “These experiences match your personal PsyCap drivers. Is this statement accurate? If not, please correct the positive or negative contributions of your PsyCap.” Each experience is transparent and can be validated based on user input.

New PsyCap driver can be captured from employees' feedback to PsyCap probing questions. For example, when the feedback indicates that “I get to work on things I'm good at” 406 or “The work I do is aligned to my passions and interests” 408, such indication can be used as new PsyCap driver. In some implementations, before being included in the XQ tool, each new PsyCap driver is tested by the XQ tool to comply with scientific standards, such as those for the scientifically-proven PsyCap drivers. Our XQ study has identified some new PsyCap drivers based on proprietary data elements included or inferred from machine learning. Examples of those new PsyCap drivers may include, but are not limited to, the following drivers:
Alignment to SAP SuccessFactors Whole Self Model
“I get to work on things I am good at.”
“The work I do is aligned to my passions and interests.”
“My company has recently been performing well financially lately.”
“I am able to see my work projects through from beginning to end.”

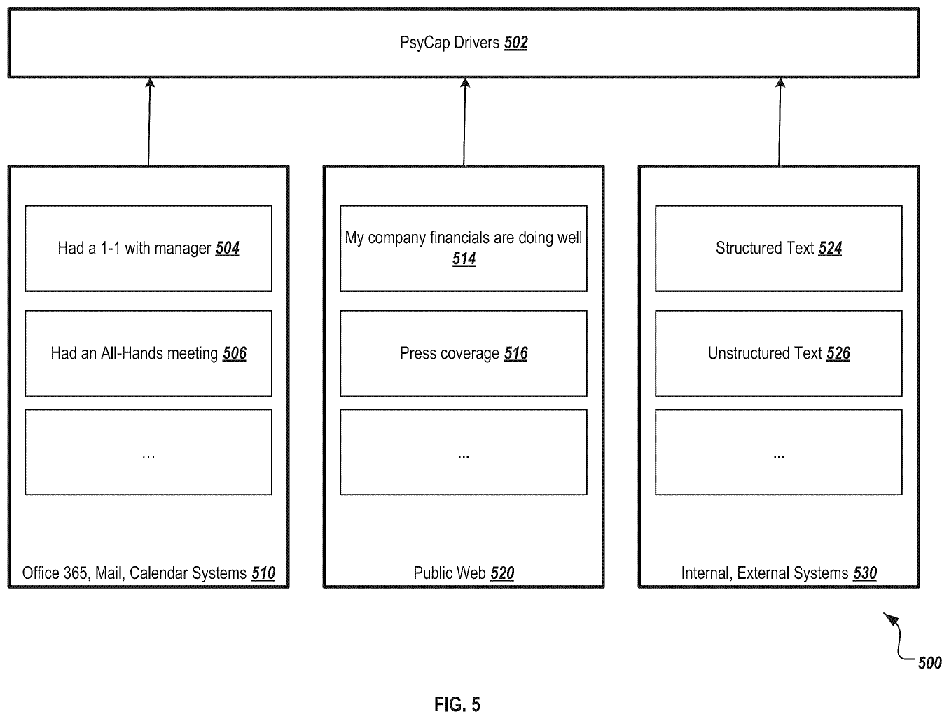

FIG. 5 is a block diagram illustrating another example aspect 500 of PsyCap drivers. As illustrated in FIG. 5, PsyCap drivers 502 can be associated with inference from Office 365, Mail, Calendar Systems 510, Public Web 520, and Internal, External Systems 530. In some implementations, the PsyCap drivers 502 can be associated with inference from additional sources, fewer sources, and/or different sources.

Experience can be inferred from data from different systems other than the HRMS. For example, experience can be inferred from events in an employee's calendar (such as, “Had a 1-1 with manager” 504 and “Had an All-Hands meeting” 506). Experience can be inferred from information on a public website (such as, “My company financials are doing well” 514 and “Press coverage” 516). Experience can be inferred from structured text 524 and unstructured text 526 from a system internal or external to an organization.

As illustrated in FIG. 5, any suitable unstructured data source, structured data source, resume and image, social media, third party system, machine learning (ML), application programming interface (API), and HyperText Transfer Protocol (HTTP) can be used to infer experience associated with one or more PsyCap drivers in the PsyCap drivers 502. For example, Natural Language Processing (NLP) techniques can be used to obtain data from unstructured data associated with the user. Optical character recognition (OCR) and/or NLP techniques can be used to obtain data from user resumes and images. Additional data can be obtained from social media (such as Facebook, LinkedIn, and Twitter), one or more third party systems, and APIs associated with one or more other data sources or systems. Any suitable alternative sources may also be used, and can be provided to the XQ tool, such as via suitable API calls, or other methods of communication.

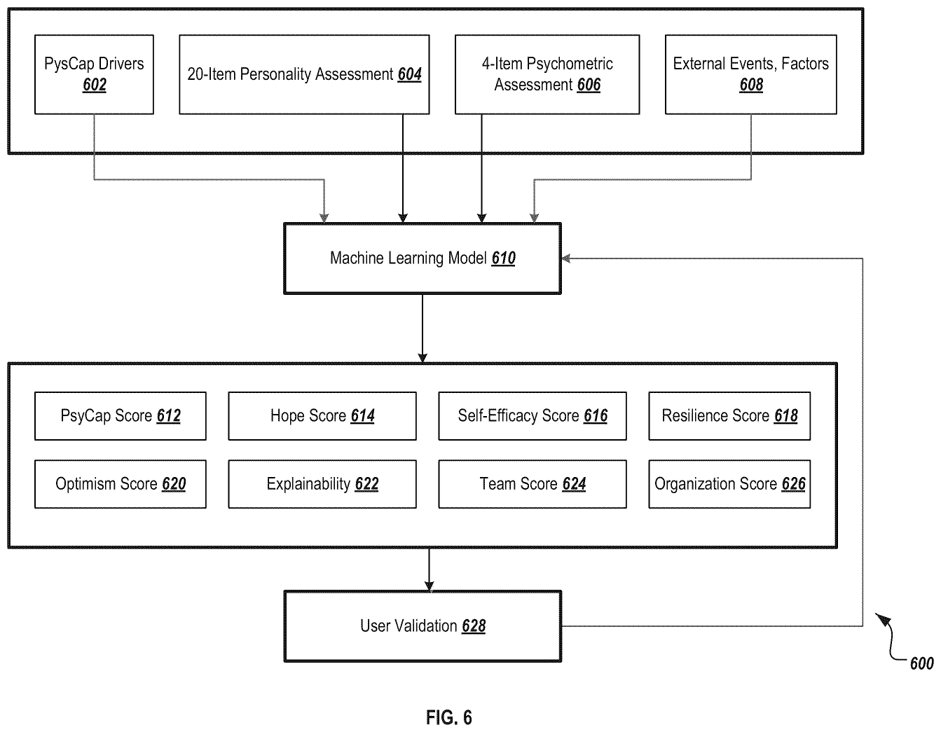

FIG. 6 is a flow diagram of an example process 600 for measuring PsyCap.

Operations of process 600 are described below as being performed by one or more components of the system 100 described above with respect to FIG. 1. For example, the process 600 can be executed by the employee management system 102 of FIG. 1. Operations of the process 600 are described below for illustration purposes only. Operations of the process 600 can be performed by any appropriate device or system, e.g., any appropriate data processing apparatus. Operations of the process 600 can also be implemented as instructions stored on a non-transitory computer readable medium. Execution of the instructions causes one or more data processing apparatus to perform operations of the process 600. In some implementations, the example process 600 can include additional, fewer, and/or different operations.

As illustrated in FIG. 6, PsyCap drivers 602, 20-item personality assessment 604, 4-item psychometric assessment 606, and external events, factors 608 are input into a machine learning model 610. The PsyCap drivers 602 includes scientifically-proven PsyCap drivers and user-identified PsyCap drivers described above with respect to FIGS. 3-5. The 20-item personality assessment 604 includes personality tests (such as the Big Five personality test). The external events, factors 608 includes structured or unstructured data from public websites and/or systems external to an organization. In some implementations, input to the machine learning model 610 can include organization or administrator defined large scale workforce events, and/or structured or unstructured data from a HRMS of the organization. In some implementations, input to the machine learning model 610 can include additional, fewer, and/or different elements.

Based on the input, the machine learning model 610 can generate PsyCap measurement for an individual, a team, and/or the organization. As illustrated in FIG. 6, output of the machine learning model 610 includes PsyCap score 612, hope score 614, self-efficacy score 616, resilience score 618, optimism score 620, explainability 622, team score 624, and organization score 626. In some implementations, the XQ tool provides output transparency settings that allow administrators to set view and interaction permissions using role-based permissions or other permission models. In some implementations, output of the machine learning model 610 can include additional, fewer, and/or different elements.

The PsyCap score 612, the hope score 614, the self-efficacy score 616, the resilience score 618, and the optimism score 620 may be related to an individual's PsyCap. For example, the PsyCap score 612 is a consolidated and higher-order construct score for the individual's PsyCap. The hope score 614, the self-efficacy score 616, the resilience score 618, and the optimism score 620 are scores for the individual's hope, self-efficacy, resilience, and optimism, respectively.

Example outputs for an individual user may include, but are not limited to, the following:
PsyCap score-aggregate
Hope score
Self-Efficacy score
Resilience score
Optimism score.
Explainability of the PsyCap score
Analytics on top PsyCap positive contributing experiences (boosters)
Analytics on top PsyCap negative contributing experiences (drainers)
Trend analysis over time
PsyCap progress badges
Analytics on top PsyCap boosters for colleagues (in same role or organization)
ML recommendations for PsyCap boosters
Comparison of PsyCap boosters and drainers to Whole Self Model
Reporting Line Team PsyCap score (mean of team member's scores)
Reporting Line Team hope, self-efficacy, resilience, and optimism scores (mean for team member's scores).
Dynamic Team PsyCap score (mean of team member's scores)
Dynamic Team PsyCap hope, self-efficacy, resilience, and optimism score (mean for team member's scores)
Organization PsyCap score (mean of organization member's scores)
Organization PsyCap hope, self-efficacy, resilience, and optimism score (mean of organization member's scores)

The explainability 622 may include context, definition, and other information related to one or more of these outputs. For example, the explainability 622 includes a percentile of the user's score compared to other members of the same team or organization. In some cases, context in terms of whether the user's score is in the low, medium, or high range is transparent to the user. In some implementations, one or more key factors that affect the user's score is provided in the explainability 622. The explainability 622 can help users understand their PsyCap trends, whether positive/upward or negative/downward over time. For example, some types of experiences (such as culture and climate) are categorized as trending positive/upward, and some types of experiences (such as work and tasks) are categorized as trending negative/downward.

The team score 624 and the organization score 626 are outputs for managers and dynamic teams. The level of PsyCap or the level of positive strength and resources has a direct impact on the organization's ability to adapt and change, to respond to challenges, and to innovate and protect. Insights into the PsyCap score, its boosters and drainers, and a multidimensional view of the team and organization provide the organization with a new competitive advantage. With the team score 624 and the organization score 626, organization and HR leaders are able to fill key information blind spots and make targeted improvements in a timely manner. Example key information blind spots may include, but are not limited to, the following:
Is my organization ready for change?
Will my organization be ready to tackle new challenges?
What is elevating and contributing to the workforce's ability to thrive?
Is my workforce operating at an optimal level where they can thrive as individuals and teams?
What experiences are negatively impacting my workforce?
How are key experiences at work contributing to the work experience and are they returning a positive return on investment in the form of PsyCap?
Which areas of my organization, location or types or roles are thriving and which are struggling?
How are we trending? Are psychological resources trending up or trending down?
What are the experience moments which matter the most to my workforce?

These insights help inform strategic decisions and increase leadership confidence in strategy or direction. The insights can also inform areas of investment into workforce programs. For example, a leadership development program was developed to increase confidence and competence of future leaders. However, the XQ tool determines that this program is one of the PsyCap drainers and has a negative impact on confidence and the PsyCap score. The XQ tool can alert the organization and HR leaders that the program has a negative return on investment (ROI) and needs to be restarted or terminated. The insights can also help identify hidden motivations within the organization where significant investments can be made to have a meaningful impact on the workforce. For example, the XQ tool determines that a social connection program is one of the PsyCap boosters and has a positive impact on the PsyCap score. The XQ tool can inform the organization and HR leaders to invest more and provide leadership support to ensure the sustainability of the social connection program.

The organization score 626 may include, but are not limited to, the following:
Organizational PsyCap score
Segmentation of organizational PsyCap score
Trend analysis over time
Comparison analysis over time
ML recommendations for organizational PsyCap boosters
Analysis and explainability of the PsyCap score
Organizational change readiness index
Analytics on top PsyCap positive contributing experiences (boosters)
Analytics on top PsyCap negative contributing experiences (drainers)

User validation 628 can be used to enhance accuracy of the machine learning model 610. For example, after generating the PsyCap measurement, the XQ tool can send a probing question to the user asking: “These experiences match your personal PsyCap drivers. Is this statement accurate? If not, please correct the positive or negative contributions of your PsyCap.” The direct user input and/or the user feedback can be used to update the machine learning model 610 to improve PsyCap measurement accuracy.

In some implementations, the machine learning model 610 can be trained and tuned as additional PsyCap drivers are identified and validated. Before being included in the XQ tool, each new PsyCap driver needs to be tested by the XQ tool to comply with scientific standards, such as those for the scientifically-proven PsyCap drivers. Testing data can include one or more of PsyCap drivers, 20-item open-source personality assessment, 4-item PsyCap pulse assessment, organization or administrator defined large scale workforce events, structured or unstructured data from a HRMS of the organization, and structured or unstructured data from public websites or systems internal or external to the organization.

For example, it can be assumed that each user does not have a PsyCap score before interacting with the XQ tool. The XQ tool can use any suitable personality assessment, including a 20-item personality assessment, to create a starting point to identify the individual's natural preferences in terms of his or her traits or work styles. In addition, the XQ tool can use 4-item pulses through the onboarding experience to create an initial baseline of the PsyCap score. The baseline is created based on work events during onboarding and user interactions that validate PsyCap boosters or PsyCap drainers. Other user-related work events in the workflow detected in the HRMS or other sources can be used to further create the PsyCap score.

Individual PsyCap changes over time as experience changes and work develops. To detect and respond to changes in PsyCap, the XQ tool includes a series of learning content, interactive exercises, and proprietary ML-supported PsyCap interventions. Many PsyCap drivers are inherent to the HRMS. Intervention boosters from 3^{rd} party content providers can be connected to HR management solutions. Both source types are inputs to the XQ tool's intelligent intervention feature. For example, hope in the workforce can be improved by setting aspirations and meaningful goals. Self-efficacy or confidence can be improved through experiential or learning sessions offered by the HR management solutions. As a result, the XQ tool can identify opportunities to optimize PsyCap among employees and recommends those opportunities to the employees.

Example ML-supported PsyCap interventions may include, but are not limited to, the following:
Opportunities for learning, jobs, careers, and connections via talent or opportunity marketplaces.
Goal setting.
Aspiration setting.
Career pathing.
Personality, strengths, and styles assessments.
Identity narrative creation: Who I am becoming?
3^{rd} party PsyCap content.

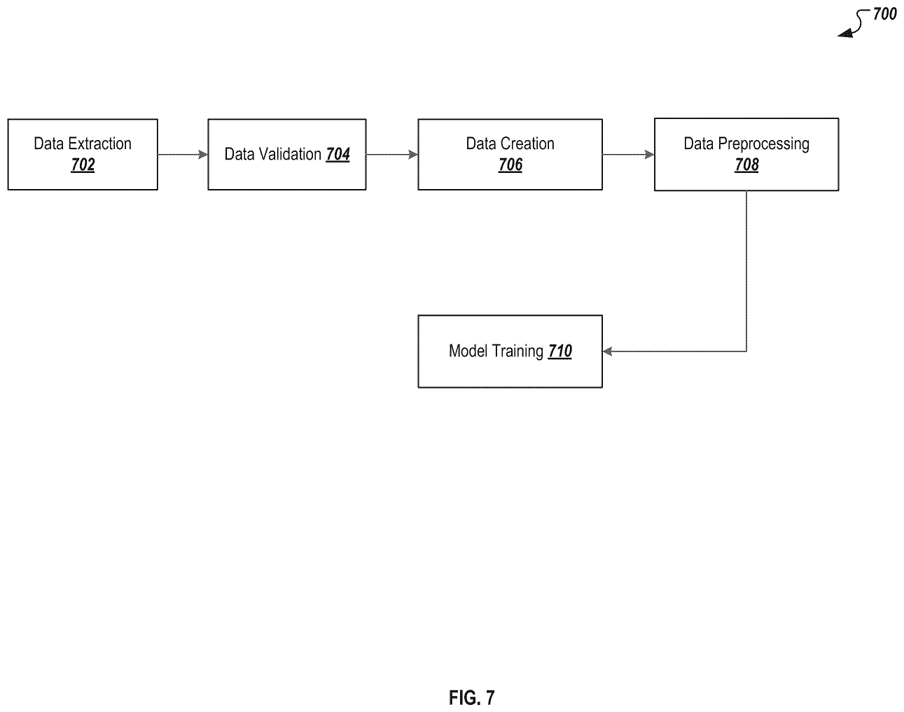

FIG. 7 is a flow diagram of an example process 700 for XQ data management. Operations of process 700 are described below as being performed by one or more components of the system 100 described above with respect to FIG. 1. For example, the process 700 can be executed by the employee management system 102 of FIG. 1. Operations of the process 700 are described below for illustration purposes only. Operations of the process 700 can be performed by any appropriate device or system, e.g., any appropriate data processing apparatus. Operations of the process 700 can also be implemented as instructions stored on a non-transitory computer readable medium. Execution of the instructions causes one or more data processing apparatus to perform operations of the process 700. In some implementations, the example process 700 can include additional, fewer, and/or different operations.

Data extraction is performed at 702. For example, when new data arrives (such as 4-item pulse response), the values of previous PsyCap and personality assessment are extracted from a database. The data corresponding to the personality assessment is captured once and are used for future inference and training until the user changes the answer to the personality assessment. In some implementations, the personality assessment can be performed multiple times (e.g., once a year).

Data validation is performed at 704. In some instances, data validation can include three tasks: checking for data anomalies, checking that the data schema has not changed, and checking that the statistics of the new dataset are still aligned with those of the previous training dataset. The first task validates the data if the values/options for the questions to user are not modified. The second task validates the data if the questions are not changed or modified. The third task uses the Kullback-Leibler (KL) divergence or the Wasserstein metric, or other suitable evaluations, to determine the distribution change between the new dataset and the previous training dataset, and validates the data if the distribution change is within a predefined range.

Data creation is performed at 706 after data is validated at 704. The user response is first converted into a time-distributed subset of responses to questions. For example, half of the questions are randomly selected at a time and an entry is created with those questions for a user. This process can be repeated 30 times per user in some instances. In the process, the data corresponding to hope, self-efficacy, optimism, and resilience remain unchanged.

Data preprocessing is performed at 708. Data preprocessing can include new user responses treatment, missing data treatment, data transformation, and data normalization, among others. In the new user responses treatment, response data for the query is obtained from the creation time of the XQ tool and response ID corresponds to the user's unique hash key. In the missing data treatment, for a first-time user of the application, a null value of a question is populated with mean of all responses to the question. For a recurring user, the null value is populated with the user's previous response. The previous PsyCap score is populated with a PsyCap score calculated from the previous response. “Prefer to not respond”, “unsure”, “maybe”, and “prefer not to say” in the response are considered as missing entries. In the data transformation, raw data is populated with numeric and/or categorical variables. For example, some ordered categorical variables are converted to a scale of 1-5, and other disordered categorical variables are converted using one-hot encoding. In the data normalization, all numeric columns are normalized to scalar standards.

Example ordered categorical variable transformations may include, but are not limited to, the following:
[(‘Strongly agree’, 5), (‘Somewhat agree’, 4), (Neither agree nor disagree’, 3), (‘Somewhat disagree’, 2), (‘Strongly disagree’, 1)]
[(‘Extremely positive’, 5), (‘Somewhat positive’, 4), (Neither positive nor negative’, 3), (‘Somewhat negative’, 2), (‘Extremely negative’, 1)]
[(‘Definitely yes’, 5), (‘Probably yes’, 4), (‘Might or might not’, 3), (‘Probably not’, 2), (‘Definitely not’, 1)].
[(‘Always’, 5), (‘Most of the time’, 4), (‘About half the time, 3), (‘Sometimes, 2), (‘Never’, 1)]
[(‘A great deal’, 4), (‘Somewhat, 3), (‘A little bit, 2), (‘Not at all’, 1)]
[(‘Yes’: 1), (‘No, 0)]

Model training is performed at 710. A machine learning model can be built to predict or measure PsyCap by using user responses to questions based on data triggers and previous PsyCap scores. For example, the model can be based on Light Gradient Boosting Machine (LightGBM) and use Root Mean Square Error (RMSE), Mean Absolute Error (MAE), and R-squared (r2) scores as performance metrics. In some implementations, the model can be retrained when certain conditions are met. For example, if the performance of the model is decreased by a certain amount (such as 30 users disagree with the PsyCap predictions), or if a large number of user feedback (such as 30% of the initial data) is consolidated, the model can be retrained using the new data and corresponding user feedback.

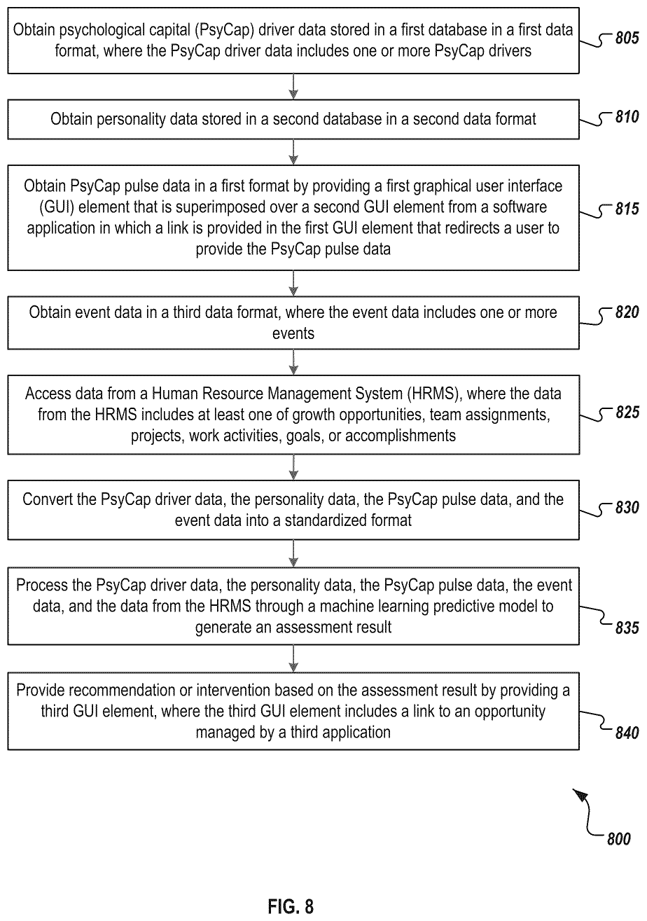

FIG. 8 is a flowchart of an example method 800 for recommending XQ intervention based on PsyCap assessment. It will be understood that method 800 and related methods may be performed, for example, by any suitable system, environment, software, and hardware, or a combination of systems, environments, software, and hardware, as appropriate. For example, one or more of a client, a server, or other computing device can be used to execute method 800 and related methods and obtain any data from the memory of a client, the server, or the other computing device. In some implementations, the method 800 and related methods are executed by one or more components of the system 100 described above with respect to FIG. 1. For example, the method 800 and related methods can be executed by the employee management system 102 of FIG. 1.

At 805, psychological capital (PsyCap) driver data stored in a first database in a first data format is obtained. The PsyCap driver data includes one or more PsyCap drivers. For example, the one or more PsyCap drivers can include one or more of Performance Goals, Development Goals, Stretch Goals, Organizational Goals, Organizational OKRs, Career Aspirations, Defined Career Path, Skill or Capability Building, Continuous Performance Activities, Leader or Manager PsyCap, Team or Organizational PsyCap, Peer or Manager Feedback, 360 or Assessed Capability Measurement, Rewards, Recognition, Growth Experiences, Psychological Safety, Climate or Culture, Projects or Work Aligned to Interests, Agency or Self Direction of Career, Manager or Leader Relationship, Social Relationships, Team Effectiveness, Job Crafting, Job Variety, Job Stability, Job Demands, Team Climate, Potential Indicators, and People Sustainability Score.

In some implementations, the one or more PsyCap drivers can include one or more of Alignment to Whole Self Model, “I get to work on things I am good at”, “The work I do is aligned to my passions and interests”, “My company has recently been performing well financially lately”, and “I am able to see my work projects through from beginning to end”.

At 810, personality data stored in a second database in a second data format is obtained. For example, the personality data can be obtained from personality tests (such as the Big Five personality test). In some instances, the personality data includes a core set of personality traits that includes openness to experience, conscientiousness, extraversion, agreeableness, and neuroticism.

At 815, PsyCap pulse data in a first format is obtained by providing a first graphical user interface (GUI) element that is superimposed over a second GUI element from a software application in which a link is provided in the first GUI element that redirects a user to provide the PsyCap pulse data. In some instances, the first GUI element is provided next to the second GUI element, or in other orientations. For example, the PsyCap pulse data can be obtained through polls during XQ onboarding. In some implementations, the PsyCap pulse data is obtained after the personality data is obtained.

At 820, event data in a third data format is obtained. The event data includes one or more events. For example, the one or more events include an event of an employee upskilled his/her proficiency in a skill/capability, an event of an employee completing a 1-1 meeting with his/her manager, and an event of an employee attending an all-hands meeting.

At 825, data from a Human Resource Management System (HRMS) is accessed. The data from the HRMS includes at least one of growth opportunities, team assignments, projects, work activities, goals, or accomplishments.

At 830, the PsyCap driver data, the personality data, the PsyCap pulse data, and the event data are converted into a standardized format.

At 835, the PsyCap driver data, the personality data, the PsyCap pulse data, the event data, and the data from the HRMS are processed through a machine learning predictive model to generate an assessment result. The assessment result includes a PsyCap score, a Hope score, a Self-Efficacy score, a Resilience score, an Optimism score, a top PsyCap positive contributing experience, and a top PsyCap negative contributing experience.

At 840, a recommendation or intervention is provided based on the assessment result by providing a third GUI element. In some instances, the intervention includes one or more recommended actions that can be taken to improve employees' PsyCap. For example, the intervention includes one or more of goal setting, aspiration setting, and career development planning. The third GUI element includes a link to an opportunity managed by a third application.

In some implementations, the personality data and the PsyCap pulse data are associated with an employee, the PsyCap result includes a PsyCap score of the employee, and providing the recommendation or the intervention based on the PsyCap result includes recommending an opportunity to the employee based on the PsyCap score of the employee.

In some implementations, the personality data and the PsyCap pulse data are associated with employees in a team, the PsyCap result includes an aggregated PsyCap score of each employee in the team, and providing the recommendation or the intervention based on the PsyCap result includes recommending a team learning or training if the aggregated PsyCap score is lower than a previously stored score.

In some implementations, the personality data and the PsyCap pulse data are associated with a team leader, the PsyCap result includes a PsyCap score of the team leader, and providing the recommendation or the intervention based on the PsyCap result includes: determining that the PsyCap score of the team leader is lower than a threshold; identifying a PsyCap driver from the one or more PsyCap drivers that cause low PsyCap score; and providing the recommendation or the intervention based on the identified PsyCap driver.

In some implementations, the personality data and the PsyCap pulse data are associated with employees in an organization, the PsyCap result includes a mean of organization employees' PsyCap scores, and providing the recommendation or the intervention based on the PsyCap result includes identifying one or more hidden boosters of motivation in the organization.

In some implementations, the example method 800 further comprises identifying a new event, sending 4-item pulse to one or more employees after the new event occurred, receiving employee feedback on the 4-item pulse, and calculating a relationship between the new event and PsyCap.

The preceding figures and accompanying descriptions illustrate example processes and computer-implementable techniques. But system 100 (or its software or other components) contemplates using, implementing, or executing any suitable technique for performing these and other tasks. It will be understood that these processes are for illustration purposes only and that the described or similar techniques may be performed at any appropriate time, including concurrently, individually, or in combination. In addition, many of the operations in these processes may take place simultaneously, concurrently, and/or in different orders than as shown. Moreover, system 100 may use processes with additional operations, fewer operations, and/or different operations, so long as the methods remain appropriate.

In other words, although this disclosure has been described in terms of certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure.

While generally described as computer implemented software embodied on tangible media that processes and transforms the respective data, some or all of the aspects may be computer implemented methods or further included in respective systems or other devices for performing this described functionality. The details of these and other aspects and embodiments of the present disclosure are set forth in the accompanying drawings and the description below. Other features, objects, and advantages of the disclosure will be apparent from the description and drawings, and from the claims.

What is claimed is:

1. A computer-implemented method comprising:
obtaining psychological capital (PsyCap) driver data stored in a first database in a first data format, wherein the PsyCap driver data includes one or more PsyCap drivers;
obtaining personality data stored in a second database in a second data format;
obtaining PsyCap pulse data in a first format by providing a first graphical user interface (GUI) element that is superimposed over a second GUI element from a software application in which a link is provided in the first GUI element that redirects a user to provide the PsyCap pulse data;
obtaining event data in a third data format, wherein the event data includes one or more events;
accessing data from a Human Resource Management System (HRMS), wherein the data from the HRMS includes at least one of growth opportunities, team assignments, projects, work activities, goals, or accomplishments;
converting the PsyCap driver data, the personality data, the PsyCap pulse data, and the event data into a standardized format;
processing the PsyCap driver data, the personality data, the PsyCap pulse data, the event data, and the data from the HRMS through a machine learning predictive model to generate an assessment result; and
providing recommendation or intervention based on the assessment result by providing a third GUI element, wherein the third GUI element includes a link to an opportunity managed by a third application.

2. The computer-implemented method of claim 1, wherein the personality data is obtained through a personality test, and the PsyCap pulse data is obtained through polls during experience quotient (XQ) onboarding and is obtained after the personality data is obtained.

3. The computer-implemented method of claim 1, wherein the assessment result includes a PsyCap score, a Hope score, a Self-Efficacy score, a Resilience score, an Optimism score, a top PsyCap positive contributing experience, and a top PsyCap negative contributing experience.

4. The computer-implemented method of claim 1, wherein the personality data and the PsyCap pulse data are associated with an employee, the PsyCap result includes a PsyCap score of the employee, and providing the recommendation or the intervention based on the PsyCap result includes recommending an opportunity to the employee based on the PsyCap score of the employee.

5. The computer-implemented method of claim 1, wherein the personality data and the PsyCap pulse data are associated with employees in a team, the PsyCap result includes an aggregated PsyCap score of each employee in the team, and providing the recommendation or the intervention based on the PsyCap result includes recommending a team learning or training if the aggregated PsyCap score is lower than a previously stored score.

6. The computer-implemented method of claim 1, wherein the personality data and the PsyCap pulse data are associated with a team leader, the PsyCap result includes a PsyCap score of the team leader, and providing the recommendation or the intervention based on the PsyCap result includes:
determining that the PsyCap score of the team leader is lower than a threshold;
identifying a PsyCap driver from the one or more PsyCap drivers that cause low PsyCap score; and
providing the recommendation or the intervention based on the identified PsyCap driver.

7. The computer-implemented method of claim 1, wherein the personality data and the PsyCap pulse data are associated with employees in an organization, the PsyCap result includes a mean of organization employees' PsyCap scores, and providing the recommendation or the intervention based on the PsyCap result includes identifying one or more hidden boosters of motivation in the organization.

8. The computer-implemented method of claim 1, further comprising:
identifying a new event;
sending 4-item pulse to one or more employees after the new event occurred;
receiving employee feedback on the 4-item pulse; and
calculating a relationship between the new event and PsyCap.

9. A system comprising:
one or more computers; and
a computer-readable medium coupled to the one or more computers having instructions stored thereon which, when executed by the one or more computers, cause the one or more computers to perform operations comprising:
obtaining psychological capital (PsyCap) driver data stored in a first database in a first data format, wherein the PsyCap driver data includes one or more PsyCap drivers;
obtaining personality data stored in a second database in a second data format;
obtaining PsyCap pulse data in a first format by providing a first graphical user interface (GUI) element that is superimposed over a second GUI element from a software application in which a link is provided in the first GUI element that redirects a user to provide the PsyCap pulse data;
obtaining event data in a third data format, wherein the event data includes one or more events;
accessing data from a Human Resource Management System (HRMS), wherein the data from the HRMS includes at least one of growth opportunities, team assignments, projects, work activities, goals, or accomplishments;
converting the PsyCap driver data, the personality data, the PsyCap pulse data, and the event data into a standardized format;
processing the PsyCap driver data, the personality data, the PsyCap pulse data, the event data, and the data from the HRMS through a machine learning predictive model to generate an assessment result; and
providing recommendation or intervention based on the assessment result by providing a third GUI element, wherein the third GUI element includes a link to an opportunity managed by a third application.

10. The system of claim 9, wherein the personality data is obtained through a personality test, and the PsyCap pulse data is obtained through polls during experience quotient (XQ) onboarding and is obtained after the personality data is obtained.

11. The system of claim 9, wherein the assessment result includes a PsyCap score, a Hope score, a Self-Efficacy score, a Resilience score, an Optimism score, a top PsyCap positive contributing experience, and a top PsyCap negative contributing experience.

12. The system of claim 9, wherein the personality data and the PsyCap pulse data are associated with an employee, the PsyCap result includes a PsyCap score of the employee, and providing the recommendation or the intervention based on the PsyCap result includes recommending an opportunity to the employee based on the PsyCap score of the employee.

13. The system of claim 9, wherein the personality data and the PsyCap pulse data are associated with employees in a team, the PsyCap result includes an aggregated PsyCap score of each employee in the team, and providing the recommendation or the intervention based on the PsyCap result includes recommending a team learning or training if the aggregated PsyCap score is lower than a previously stored score.

14. The system of claim 9, wherein the personality data and the PsyCap pulse data are associated with a team leader, the PsyCap result includes a PsyCap score of the team leader, and providing the recommendation or the intervention based on the PsyCap result includes:
determining that the PsyCap score of the team leader is lower than a threshold;
identifying a PsyCap driver from the one or more PsyCap drivers that cause low PsyCap score; and
providing the recommendation or the intervention based on the identified PsyCap driver.

15. The system of claim 9, wherein the personality data and the PsyCap pulse data are associated with employees in an organization, the PsyCap result includes a mean of organization employees' PsyCap scores, and providing the recommendation or the intervention based on the PsyCap result includes identifying one or more hidden boosters of motivation in the organization.

16. The system of claim 9, the operations further comprising:
identifying a new event;
sending 4-item pulse to one or more employees after the new event occurred;
receiving employee feedback on the 4-item pulse; and
calculating a relationship between the new event and PsyCap.

17. A computer program product encoded on a non-transitory storage medium, the product comprising non-transitory, computer readable instructions for causing one or more processors to perform operations comprising:
obtaining psychological capital (PsyCap) driver data stored in a first database in a first data format, wherein the PsyCap driver data includes one or more PsyCap drivers;
obtaining personality data stored in a second database in a second data format;
obtaining PsyCap pulse data in a first format by providing a first graphical user interface (GUI) element that is superimposed over a second GUI element from a software application in which a link is provided in the first GUI element that redirects a user to provide the PsyCap pulse data;
obtaining event data in a third data format, wherein the event data includes one or more events;
accessing data from a Human Resource Management System (HRMS), wherein the data from the HRMS includes at least one of growth opportunities, team assignments, projects, work activities, goals, or accomplishments;
converting the PsyCap driver data, the personality data, the PsyCap pulse data, and the event data into a standardized format;
processing the PsyCap driver data, the personality data, the PsyCap pulse data, the event data, and the data from the HRMS through a machine learning predictive model to generate an assessment result; and
providing recommendation or intervention based on the assessment result by providing a third GUI element, wherein the third GUI element includes a link to an opportunity managed by a third application.

18. The computer program product of claim 17, wherein the personality data is obtained through a personality test, and the PsyCap pulse data is obtained through polls during experience quotient (XQ) onboarding and is obtained after the personality data is obtained.

19. The computer program product of claim 17, wherein the assessment result includes a PsyCap score, a Hope score, a Self-Efficacy score, a Resilience score, an Optimism score, a top PsyCap positive contributing experience, and a top PsyCap negative contributing experience.

20. The computer program product of claim 17, wherein the personality data and the PsyCap pulse data are associated with an employee, the PsyCap result includes a PsyCap score of the employee, and providing the recommendation or the intervention based on the PsyCap result includes recommending an opportunity to the employee based on the PsyCap score of the employee.
